(19) United States
(12) Patent Application Publication
(10) Pub. No.: US 2015/0249845 A1
(43) Pub. Date: Sep. 3, 2015

(54) LIVE VIDEO BROADCASTING FROM A MOBILE DEVICE

(71) Applicant: Life On Air Inc., San Francisco, CA (US)

(72) Inventors: Roi Tirosh, Tel Mond (IL); Ben Rubin, Raanana (IL); Itai Danino, Caesarea (IL)

(21) Appl. No.: 14/427,859

(22) PCT Filed: Sep. 12, 2013
(86) PCT No.: PCT/IL2013/050781

§ 371 Date: Mar. 12, 2015

Related U.S. Application Data
(60) Provisional application No. 61/700,397, filed on Sep. 13, 2012.

(51) Int. Cl. H04N 21/2187; H04H 60/05; H04N 21/414; H04N 21/437; H04H 20/71; H04N 21/845; H04N 21/239; H04N 21/24; H04L 12/18; H04N 21/61

(52) U.S. Cl. CPC H04N 21/2187; H04L 12/1877; H04L 12/1881; H04L 12/189; H04H 60/05; H04N 21/41407; H04N 21/6181; H04H 20/71; H04N 21/8456; H04N 21/239; H04N 21/2408; H04N 21/437

(57) ABSTRACT

A method for distributing live video broadcasted by a mobile computing device, the method being carried out by one or more hardware processors of one or more servers connected to said mobile computing device over a computer network, the method comprising: receiving sequential video segments of upload bandwidth-optimized lengths from said mobile computing device, the sequential video segments constituting a live video broadcast captured by a digital camera of said mobile computing device; appending said sequential video segments to a Transport Stream (TS) container residing in a buffer memory; segmenting said TS container into distribution-ready TS segments of download bandwidth-optimized lengths, and appending a Uniform Resource Identifier (URI) of each TS segment of said TS segments to a playlist file; and serving said playlist file via Hyper Text Transfer Protocol (HTTP) to a plurality of clients configured to sequentially download said TS segments via HTTP and play downloaded TS segments, wherein said clients are mobile computing devices and/or stationary computing devices.

### FIELD OF THE INVENTION

The invention relates to live video broadcasting from a mobile device.

### BACKGROUND

The capability of broadcasting live video from the field has been, until recently, mainly in the hands of professional TV networks or other professionally-equipped organizations. The smart phone revolution has now brought this functionality to the hands of almost every smart phone user, literally. Smart phones are mobile computerized devices which are commonly equipped with a digital camera and a network interface, allowing them to capture video and transmit it over a network, such as the Internet.

However, smart phones still suffer from many network problems, resulting from poor cellular reception, over-crowded cellular network, problematic WLAN (Wireless Local Area Network, also “WiFi”) hotspost, and the like. As a result, the amount of bandwidth available to such smart phones in the field is inconsistent and in some cases even insufficient for proper video broadcasting tasks.

There is therefore still a need in the art for devices, systems and methods for live video broadcasting by a mobile computing device, for distribution of the live video by a server, and for receiving and playing the live video at multiple client computing devices—all while overcoming the aforementioned network problems.

### SUMMARY

There is provided, according to some embodiments, a method for live video broadcasting, comprising: using at least one hardware processor of a mobile computing device, initiating a video stream capture via a digital camera of said mobile computing device; and using said at least one hardware processor, continuously dividing said video stream into sequential segments, and sequentially uploading said segments, over a computer network, to a remote server, wherein said dividing comprises setting a length of each segment of said sequential segments based on a speed at which an earlier segment of said sequential segments was uploaded to said remote server, so as to maintain reliability of the live video broadcasting when a bandwidth of said computer network fluctuates.

There is further provided, according to some embodiments, a non-transitory computer-readable medium having computer-readable code for live video broadcasting stored thereon, that, when executed by at least one hardware processor of a mobile computing device, causes the mobile computing device to: initiate a video stream capture using a digital camera of said mobile computing device; and continuously divide said video stream into sequential segments, and sequentially upload said segments, over a computer network, to a remote server, wherein the dividing comprises setting a length of each segment of said sequential segments based on a speed at which an earlier segment of said sequential segments was uploaded to said remote server, so as to maintain reliability of the live video broadcasting when a bandwidth of said computer network fluctuates.

There is further provided, according to some embodiments, a method for distributing live video broadcasted by a mobile computing device, the method, the method comprising, using at least one hardware processor of at least one server connected to said mobile computing device over a computer network: receiving sequential video segments of upload bandwidth-optimized lengths from said mobile computing device, the sequential video segments constituting a live video broadcast captured by a digital camera of said mobile computing device; appending said sequential video segments to a Transport Stream (TS) container residing in a buffer memory; segmenting said TS container into distribution-ready TS segments of download bandwidth-optimized lengths, and appending a Uniform Resource Identifier (URI) of each TS segment of said TS segments to a playlist file; and serving said playlist file via HyperText Transfer Protocol (HTTP) to a plurality of clients configured to sequentially download said TS segments via HTTP and play downloaded TS segments, wherein said clients are mobile computing devices and/or stationary computing devices.

There is further provided, according to some embodiments, a non-transitory computer-readable medium having computer-readable code for live video broadcasting stored thereon, that, when executed by at least one hardware processor of at least one server, causes the at least one server to: receive sequential video segments of upload bandwidth-optimized lengths from said mobile computing device, the sequential video segments constituting a live video broadcast captured by a digital camera of said mobile computing device; append said sequential video segments to a Transport Stream (TS) container residing in a buffer memory; segment said TS container into distribution-ready TS segments of download bandwidth-optimized lengths, and append a Uniform Resource Identifier (URI) of each TS segment of said TS segments to a playlist file; and serve said playlist file via HyperText Transfer Protocol (HTTP) to a plurality of clients configured to sequentially download said TS segments via HTTP and play downloaded TS segments, wherein said clients are mobile computing devices and/or stationary computing devices.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIG. 1 shows a network diagram of an exemplary live video broadcasting scenario;

FIG. 2 shows a packet diagram demonstrating optimization of the upload of video data to the server; and

FIG. 3 shows a flow chart of a method for live video broadcasting.

### DETAILED DESCRIPTION

Disclosed herein are devices, systems and methods for live video broadcasting by a mobile computing device, for distribution of the live video by a server, and for receiving and playing the live video at multiple client computing devices.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a hardware processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

In one exemplary scenario, a user of a mobile computing device, such as a smart phone, may use her smart phone to broadcast live video from her present whereabouts to multiple client computing devices, such as smart phones, of other users. The broadcasting may be done, for example, over a wide-area computer network such as the Internet. When the broadcasting user begins her broadcast, the server may push a notification to any client computing device subscribed to broadcasts of that broadcasting user. Users of the client computing devices may choose to decline or receive the broadcast, in which latter case the server may serve the live video to the clients using a protocol such as HTTP (HyperText Transfer Protocol) Live Streaming (also known as “HLS”) which is compatible with many mobile computing platforms. Further examples of protocols which may be suitable include HTTP Dynamic Streaming (also “HDS”) and HTTP Smooth Streaming.

Internet connection of mobile computing devices is known to be prone to connectivity issues such as speed drops and disconnects, especially if cellular broadband connection is used, but also when connecting through occasional WiFi (Wireless Fidelity) hotspots. Advantageously, in the broadcasting by the mobile computing device (hereinafter the “broadcasting device”), it may optimize the upload of video data to the server, so that client computing devices which finally receive the broadcast (hereinafter the “receiving devices”) do not experience (or experience less) interference due to connectivity issues of the broadcasting device.

The broadcasting device may carry out the optimization by dividing the video data into segments of dynamically-set lengths. This segmentation should not be confused with the segmentation of video data by a broadcast server, as prescribed by HLS. See R. Pantos, W. May, “HTTP Live Streaming”, IETF Internet Draft v. 08, Mar. 23, 2012, which is incorporated herein by reference in its entirety. The lengths may be dynamically determined, for example, by estimating network quality evident from an upload speed of an earlier segment. A higher speed may enable longer segments while a lower speed may dictate shorter segments, since shorter segments are less prone, statistically, to interference resulting from, for example, unpredictably-changing bandwidth and/or latency fluctuations in the network.

Additionally or alternatively, the broadcasting device may carry out the optimization by dynamically setting a quality of each segment based on the estimated network quality. The lengths may be dynamically determined, for example, by estimating network quality evident from an upload speed of an earlier segment. A higher speed may enable higher-quality segments while a lower speed may dictate lower-quality segments.

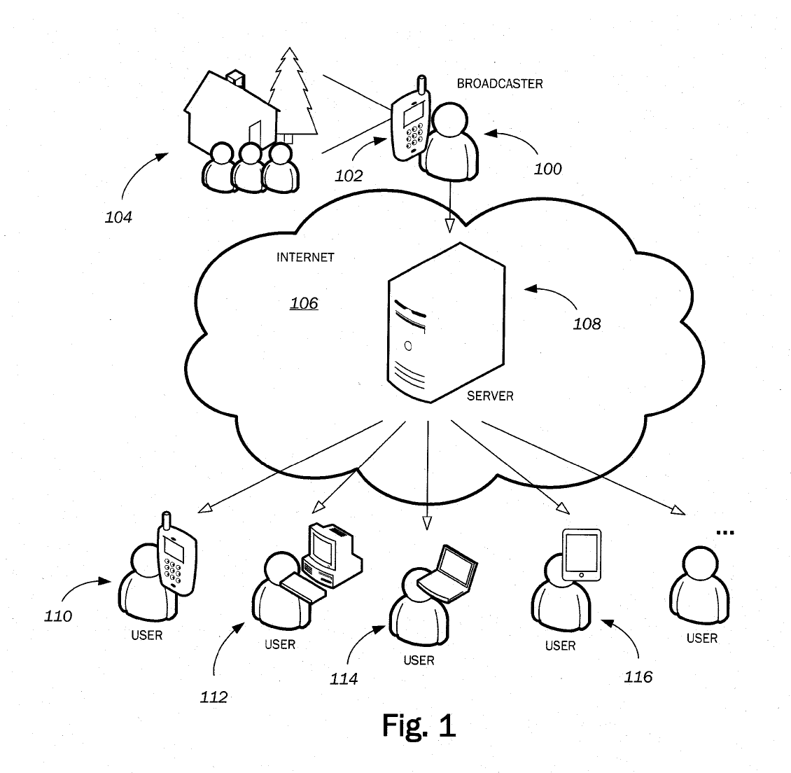

Reference is now made to FIG. 1, which shows a network diagram of an exemplary live video broadcasting scenario, in accordance with present embodiments. A broadcasting user 100 (hereinafter “broadcaster”) may utilize her broadcasting device, such as smart phone 102 which is equipped with a digital camera, to capture and broadcast live video, for example of a scenery 104. Smart phone 102 is equipped with a hardware network interface, enabling it to connect to a wide area network (WAN) such as the Internet, etc. The captured video is broadcasted by smart phone 102, through, for example, the Internet 106, to one or more hardware servers such as a hardware server 108. From server 108 or from one or more different, interconnected hardware servers (not shown), the video is distributed to multiple users of receiving devices, such as a user of a mobile computing device 110, a user of a desktop computer 112, a user of a portable computer 114, a user of a tablet computer 116, and/or the like.

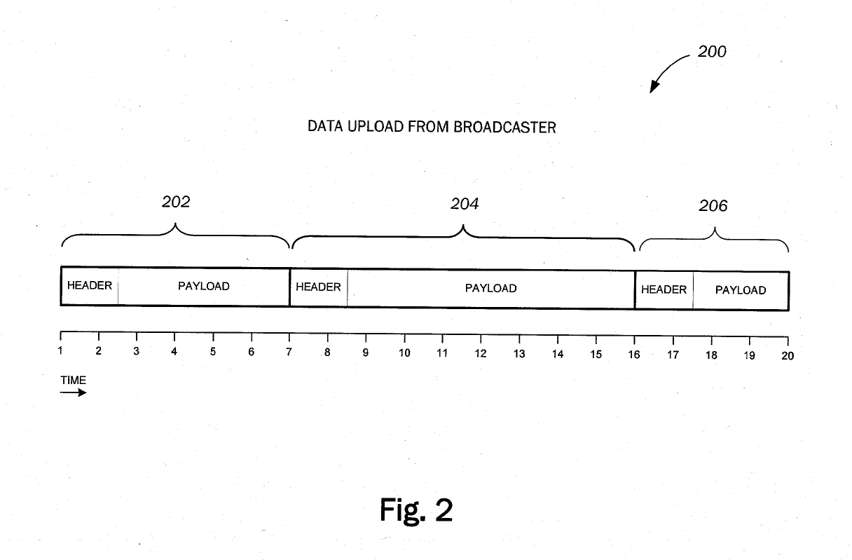

Reference is now made to FIG. 2, which shows a packet diagram 200 demonstrating optimization of the upload of video data to the server, in accordance with present embodiments. Packet diagram 200 is shown with a time axis, but numbers on the axis do not necessarily represent any specific time units, which may be different from case to case.

When the user starts broadcasting live video to the server, a first segment 202 may be of a pre-determined, arbitrary length, since connectivity issues have not been assessed yet. Similarly, first segment 202 may be of a pre-determined, arbitrary quality. This quality may be relatively low, to increase the chances of successful, fast transmission of this segment. That is, since no network statistics are available when transmitting first segment 202, it may be useful to transmit it with a relatively low quality. For example, the quality may be a bit rate of approximately 128 kilobit per second (Kbit/sec) or less, or 256 Kbit/sec or less. The term “approximately”, as used along the specification, refers to ±10% of the specified value.

Segment 202 may include a header, which identifies the broadcasting user using a unique ID, and a payload, which contains the video data.

During the transmission of segment 202 to the server, the broadcasting device may monitor and take notes of bandwidth parameters, such as average upload speed, amplitude and length of bandwidth fluctuations, and/or the like. This information on bandwidth parameters may be used later to optimize the rest of the upload of the video data.

Assume, for example, that the transmission of segment 202 was smooth and that the bandwidth parameters were satisfactory. In other words, the speed of transmission of segment 202 was fast. In such case, a consecutive segment, namely—a second segment 204, may have a longer payload, which correlates to the bandwidth parameters of the previous segment, first segment 202. Additionally or alternatively, second segment 204 may be of a relatively high quality, given the satisfactory network parameters. This quality may be, for example, approximately 256 Kbit/sec, approximately 512 Kbit/sec, or the like.

Again, during the transmission of second segment 204, bandwidth parameters are monitored. If, for example, these parameters now show deterioration, such as a lower average upload speed, too frequent or too intense fluctuation, etc., then a subsequent segment, namely—a third segment 206, may have a shorter length, which is correlated to the bandwidth parameters of the previous segment, second segment 204. Additionally or alternatively, second segment 204 may be of a relatively low quality, given the satisfactory network parameters. This quality may be, for example, approximately 256 Kbit/sec, approximately 128 Kbit/sec, or the like.

Monitoring of bandwidth parameters and re-adjustment of segment length may continue throughout the broadcast, for subsequent segments. Generally, a quality of a certain segment is set to a bit rate equal to or lower than an upload bit rate of the preceding segment. For example, if the upload bit rate of the preceding segment was 600 Kbit/sec, than the quality of the segment following it may be set to 512 Kbit/sec. This rule may be generalized as follows:

Bₙ<Bₙ₋₁

Wherein a bit rate (B) of the n^{th} segment may be equal to or lower than a bit rate of the n−1^{h} segment.

In another embodiment (not shown), also a second segment may be of a pre-determined, arbitrary quality, optionally the same as the first segment. Namely, the two initial segments are transmitted at an arbitrary quality. This quality may be relatively low, to increase the chances of successful, fast transmission of these segments. For example, the quality may be a bit rate of approximately 128 kilobit per second (Kbit/sec) or less, or 256 Kbit/sec or less. The term “approximately”, as used along the specification, refers to ±10% of the specified value.

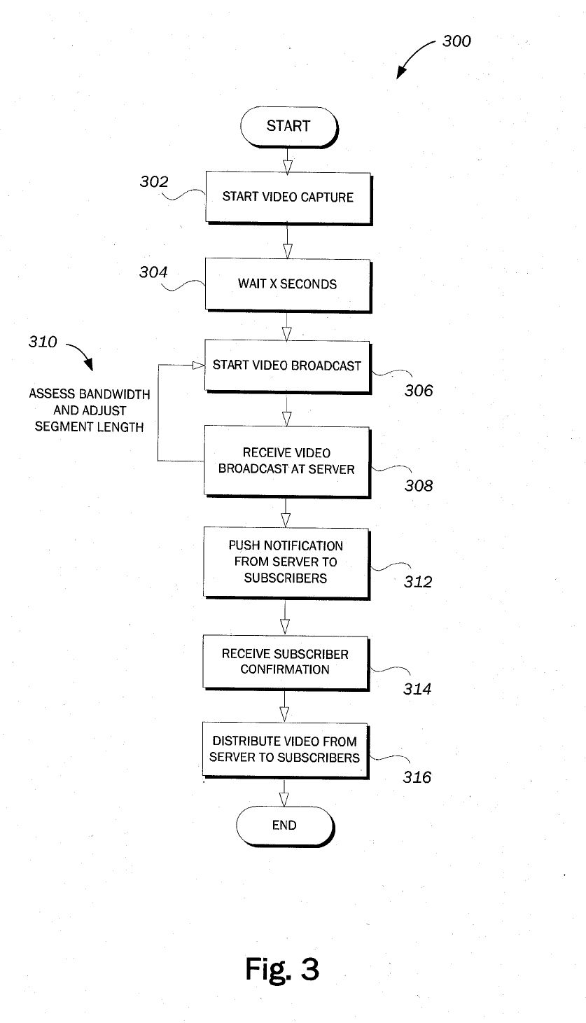

Reference is now made to FIG. 3, which shows a flow chart of a method for live video broadcasting 300, according to present embodiments. In a step 302, the broadcasting user starts capturing video using her broadcasting device. In an optional step 304, the broadcasting device waits for a pre-determined period before actually starting to broadcast the video to the server. This may be used as a safety mechanism, to prevent accidental initiation of broadcasting. It is assumed that if a video capture has not been terminated by the user for an X number of seconds, for example 5-10 seconds, then the capture is intentional.

After the wait, in a step 306, the broadcasting device starts broadcasting the video, namely—starts uploading the video data to the server. If the waiting of optional step 304 has been made, then the broadcasting will not be completely live, but rather delayed by a number of seconds—according to the length of the waiting. Alternatively, the video captured during the waiting may be discarded, and only video from that point on is uploaded to the server, such that the video broadcast is essentially “live”.

In a step 308, the broadcasted video is received at the server. As discussed above, the upload of the video data may be done in segments, in order to be able to optimize the upload. In a step 310, segments are consecutively prepared by the broadcasting device and uploaded to the server, while constantly assessing bandwidth and adjusting subsequent segment length accordingly. Steps 306-310 may be repeated throughout the rest of method 300.

In a step 312, which may be carried out immediately when the server receives the first segment of the broadcast, notifications to other users, who are subscribed to broadcasts by the broadcasting users, may be pushed by the server. The notifications may be pushed using any suitable technology, such as the Apple Push Notification Service, the Android Cloud to Device Messaging Service, email message, SMS message, etc.

In a step 314, each subscriber is presented with the option of confirming or denying receipt of the broadcast. In a step 316, the video is distributed by the server to those subscribers who confirmed the receipt.

There is further provided, in accordance with present embodiments, a method for decreasing a video broadcasting delay caused by the broadcaster. That is, the method may make the video broadcast as “live” as possible. The significance of having an essentially “live” broadcast is high. For example, it may be desired to enable textual chat between the broadcaster and one or more recipients during the broadcast. If the delay in the broadcast is high, textual messages may be received out-of-context, not in synchronization with the video.

The method for decreasing a video broadcasting delay may maintain a delay counter during the broadcasting of the video. Optionally, the delay counter is saved in and maintained by the broadcasting device. The delay counter is updated after each segment is transmitted. If the transmission of the latest segment has increased the delay count, and/or if the delay count following that transmission of the latest segment is larger than a predetermined threshold, than the next segment may be adjusted in order to decrease the delay. The adjustment may be, for example, of a length of a segment and/or of a quality of a segment. Consider the following example:
1. The initial delay counter is zero (0).
2. Segment n−1 has a quality of 512 Kbit/sec and a length of 7 seconds. This segment is uploaded at 300 Kbit/sec on average.
3. Following the transmission of segment n−1, the delay counter is increased by 3 seconds, since the upload rate was lower from the bit rate of the video.
4. In order to lower the delay, segment n is adjusted to a quality of 256 Kbit/sec and a length of 4 seconds.
5. Segment n is uploaded at 400 Kbit/sec on average. This decreases the delay counter by 2 seconds, making it 1 seconds.
6. In order to further lower the delay, segment n+1 n is adjusted to a quality of 256 Kbit/sec and a length of 4 seconds.
7. Segment n+1 is uploaded at 700 Kbit/sec on average. This decreases the delay counter to 0 seconds.

A software application for live video broadcast, according to some exemplary embodiments, may be configured for operation on a mobile computing device such as a smart phone, which may be used by the broadcasting user and/or by the receiving users.

In the description and claims of the application, each of the words “comprise” “include” and “have”, and forms thereof, are not necessarily limited to members in a list with which the words may be associated. In addition, where there are inconsistencies between this application and any document incorporated by reference, it is hereby intended that the present application controls.

1. A method for live video broadcasting, comprising:
using at least one hardware processor of a mobile computing device, initiating a video stream capture via a digital camera of said mobile computing device; and
using said at least one hardware processor, continuously dividing said video stream into sequential segments, and sequentially uploading said segments, over a computer network, to a remote server,
wherein said dividing comprises setting a length of each segment of said sequential segments based on a speed at which an earlier segment of said sequential segments was uploaded to said remote server, so as to maintain reliability of the live video broadcasting when a bandwidth of said computer network fluctuates.

2. The method according to claim 1, wherein said dividing further comprises setting a quality of each segment of said sequential segments based on the speed at which the earlier segment of said sequential segments was uploaded to said remote server, so as to enhance the reliability of the live video broadcasting when the bandwidth of said computer network fluctuates.

3. The method according to claim 2, wherein the quality of at least an initial segment of said sequential segments is approximately 256 Kbit/sec or less.

4. The method according to claim 2, wherein the quality of at least two initial segments of said sequential segments is approximately 256 Kbit/sec or less.

5. The method according to claim 2, wherein the quality of at least an initial segment of said sequential segments is approximately 128 Kbit/sec or less.

6. The method according to claim 2, wherein the quality of at least two initial segments of said sequential segments is approximately 128 Kbit/sec or less.

7. A non-transitory computer-readable medium having computer-readable code for live video broadcasting stored thereon, that, when executed by at least one hardware processor of a mobile computing device, causes the mobile computing device to:
initiate a video stream capture using a digital camera of said mobile computing device; and
continuously divide said video stream into sequential segments, and sequentially upload said segments, over a computer network, to a remote server,
wherein the dividing comprises setting a length of each segment of said sequential segments based on a speed at which an earlier segment of said sequential segments was uploaded to said remote server, so as to maintain reliability of the live video broadcasting when a bandwidth of said computer network fluctuates.

8. The non-transitory computer-readable medium according to claim 7, wherein said divide further comprises setting a quality of each segment of said sequential segments based on the speed at which the earlier segment of said sequential segments was uploaded to said remote server, so as to enhance the reliability of the live video broadcasting when the bandwidth of said computer network fluctuates.

9. The non-transitory computer-readable medium according to claim 8, wherein the quality of at least an initial segment of said sequential segments is approximately 256 Kbit/sec or less.

10. The non-transitory computer-readable medium according to claim 8, wherein the quality of at least two initial segments of said sequential segments is approximately 256 Kbit/sec or less.

11. The non-transitory computer-readable medium according to claim 8, wherein the quality of at least an initial segment of said sequential segments is approximately 128 Kbit/sec or less.

12. The non-transitory computer-readable medium according to claim 8, wherein the quality of at least two initial segments of said sequential segments is approximately 128 Kbit/sec or less.

13. A method for distributing live video broadcasted by a mobile computing device, the method comprising, using at least one hardware processor of at least one server connected to said mobile computing device over a computer network:
receiving sequential video segments of upload bandwidth-optimized lengths from said mobile computing device, the sequential video segments constituting a live video broadcast captured by a digital camera of said mobile computing device;
appending said sequential video segments to a Transport Stream (TS) container residing in a buffer memory;
segmenting said TS container into distribution-ready TS segments of download bandwidth-optimized lengths, and appending a Uniform Resource Identifier (URI) of each TS segment of said TS segments to a playlist file; and
serving said playlist file via HyperText Transfer Protocol (HTTP) to a plurality of clients configured to sequentially download said TS segments via HTTP and play downloaded TS segments, wherein said clients are mobile computing devices and/or stationary computing devices.

14. The method according to claim 13, wherein said upload bandwidth-optimized lengths of said sequential video segments are based on a speed at which an earlier segment of said sequential video segments was uploaded to said remote server.

15. The method according to claim 13, wherein said sequential video segments are further of bandwidth-optimized quality, said quality being based on the speed at which the earlier segment of said sequential video segments was uploaded to said remote server.

16. The method according to claim 15, wherein the quality of at least an initial segment of said sequential video segments is approximately 256 Kbit/sec or less.

17. The method according to claim 15, wherein the quality of at least two initial segments of said sequential video segments is approximately 256 Kbit/sec or less.

18. The method according to claim 15, wherein the quality of at least an initial segment of said sequential video segments is approximately 128 Kbit/sec or less.

19. The method according to claim 15, wherein the quality of at least two initial segments of said sequential segments is approximately 128 Kbit/sec or less.

20-25. (canceled)
